(19) United States
(12) Patent Application Publication
(10) Pub. No.: US 2011/0290713 A1
(43) Pub. Date: Dec. 1, 2011

(54) SINGLE OR MULTI-LAYER FILTER MATERIAL AND METHOD FOR THE PRODUCTION THEREOF

(76) Inventors: Werner Hörl, Feldkirchen-Westerham (DE); Jürgen Nientiedt, Grosskarolinenfeld (DE); Ulrike Kahl, Bruckmuhl (DE)

(21) Appl. No.: 13/146,289

(22) PCT Filed: Nov. 5, 2009
(86) PCT No.: PCT/EP2009/007934

§ 371 Date: Jul. 26, 2011

(30) Foreign Application Priority Data
Jan. 29, 2009 (DE) 1020090065849

(51) Int. Cl. B01D 39/14; B01D 39/18; B01D 39/20; B32B 38/08

(52) U.S. Cl. 210/491; 156/221; 210/508; 210/509

(57) ABSTRACT

The invention relates to a single or multi-layer filter material, comprising at least one layer made of cellulose, glass fiber, synthetic fiber, or a mixture thereof, and saturated with a binding agent made of an epoxy resin and a curing agent. The hardening agent comprises a first hardener cross-linking at a lower temperature, and a second hardener cross-linking at a higher temperature, so that the epoxy resin can be hardened stepwise depending on the temperature.

This application is a U.S. national phase application of International Application No. PCT/EP2009/007934, filed Nov. 5, 2009, which designated the U.S. and claims priority to Germany Application No. 102009006584.9, filed Jan. 29, 2009, the entire contents of which is hereby incorporated by reference.

### FIELD OF THE INVENTION

The invention relates to impregnated filter materials which do not release phenol or formaldehyde into the environment either during processing or during use, filter elements produced from said filter materials and a method for producing a filter material.

### BACKGROUND TO THE INVENTION

Filter materials for the automobile sector and industrial applications generally consist of cellulose and/or synthetic fibres. These filter materials are mainly used for filtering fuels, oils, gases, water and mixtures thereof. In this case, high requirements are set with regard to bursting strength and rigidity in wet and dry states. In addition, these filter materials should withstand aggressive environmental conditions and high temperatures.

Porous webs made of cellulose, glass fibres, synthetic fibres or a mixture thereof are used as a base material for these filters. Since the selection of suitable fibres type is geared mainly to the porosity, air permeability and density requirements of the filter material produced, for the most part the selected fibre types are not optimal in terms of strength.

In order nevertheless to achieve the necessary strength and rigidity, particularly when wet, and to make the filter materials resistant to aggressive influences, even at high temperatures, said filter materials are treated with a binder. For many years, phenolic resole resins or phenolic novolac resins have proved to be suitable binders, the latter in combination with hexamethylenetetramine or other formaldehyde releasers (for example, resol and polymers containing methylol groups) as hardeners. An example of a phenolic resin system of this type is described in EP 94165 A2.

These resin systems are used as solutions, the porous webs made of cellulose and/or synthetic fibres being impregnated with said solutions and then dried. Suitable solvents are low alcohols and ketones, for example methanol, ethanol, isopropanol and acetone, but also water.

The resin hardens in part during the drying process, the hardening process being controlled via the drying temperature and the duration of the drying process. A particular initial strength of the filter material which is required for the further processing thereof is achieved by the degree of hardness set. The initial strength is particularly important if the filter material is grooved in the longitudinal direction. It must be rigid enough that the grooves remain, but must not be so brittle that the filter material breaks during further processing, for example during folding. However, the hardening reaction is not easy to control and the resin is usually excessively hardened. The filter material may thus become brittle. For producing filter elements, the filter material is usually embossed and folded to form a bellows. Filter material which has too high a degree of hardness is brittle and breaks easily during this processing step.

After the embossing and folding process, the bellows is placed in a hardening oven to harden the resin completely. As a result, the strength and rigidity required for the application are achieved in both the dry and wet states and the filter material becomes resistant to aggressive influences at high temperatures. Considerable amounts of phenol and formaldehyde which are harmful to human health are released into the environment both during the drying process after impregnation of the porous web with the resin and during hardening of the resin after production of the bellows. The phenol and part of the formaldehyde are contained as impurities in the resin itself. However, the majority of the formaldehyde is released as a reaction product during the cross-linking reaction.

Therefore, in the past efforts were made to replace phenolic resins with binders which are free from phenol and formaldehyde. Water-based synthetic resin dispersions, usually acrylate resins, are increasingly being used to replace phenolic resins. These dispersions initially contain no free phenol and often no combined or free formaldehyde. However, these binders must be hardened in order to achieve the required strength and rigidity, particularly when wet, and for resistance to aggressive influences such as hot engine oil. Thermal hardening is carried out, usually by means of reactive groups located in the matrices of the synthetic resin polymers. A popular reactive group for thermal cross-linking is N-methylolacrylamide, but this splits off formaldehyde again during the cross-linking reaction. A further drawback of the use of synthetic resin dispersions as binders for filter materials is the capacity of these binders to form films during the drying process. As so-called sails, the films bridge the spaces between two or more fibres and thus reduce the pore diameter and thus the permeability for the medium to be filtered. This negative property becomes even more noticeable the higher the binder content in the filter material. Owing to the considerably shorter chain length of their molecules, phenolic resins, on the other hand, do not form films during the drying process and therefore also do not reduce the permeability for the medium to be filtered. The chemical stability and mechanical stability of filter media of this type which have been impregnated with synthetic resin dispersions of this type are inferior to those of filter media which have been impregnated with phenolic resin, and are usually insufficient for applications in fuels and oils.

A further possibility for producing a filter material without releasing any phenol or formaldehyde into the environment is the use of epoxy resin. Epoxy resin also does not contain any free phenol or formaldehyde resulting from production. Also, no formaldehyde is split off and released into the environment during the various cross-linking reactions. However, epoxy resin systems have considerable disadvantages compared to phenolic resin systems in the case of impregnation and subsequent crying. Epoxy resins always require a hardener for hardening. In this case there are basically two types: cold and hot cross-linking hardeners. However, epoxy resin impregnations using exclusively cold cross-linking hardeners can sometimes react so quickly that the filter material is already completely hardened after the drying process or hardens within hours at room temperature. As a result, the filter material is brittle and can only be further processed under difficult conditions. Embossing and folding is only possible with difficulty.

Epoxy resin impregnations using exclusively of cross-linked hardeners react considerably more slowly than phenolic resin systems. In order to achieve the degree of hardness required for further processing, the filter medium impregnated with epoxy resin must remain in the dryer considerably longer than a filter material impregnated with phenolic resin. For these reasons, epoxy resin impregnations have thus far been used only very rarely for filter materials.

### SUMMARY OF THE INVENTION

The object of the invention is therefore to provide a filter material, in particular for automobile and industrial filters, which does not release any phenol or formaldehyde into the environment and which has excellent properties, in particular with regard to filtering properties, resistance to aggressive influences, even at high temperatures, strength and rigidity in dry and wet states and with regard to good further processing. An improved filter element and a method for producing the filter material which is easy to carry out are also to be provided.

This object is achieved according to the invention by the features of claims 1, 10 and 15. Advantageous embodiments of the invention are described in the further claims.

### DETAILED DESCRIPTION OF THE INVENTION

### Embodiments

The filter material according to the invention consists of a porous, fibrous planar formation and a binder in the form of an epoxy resin impregnation which makes stepwise hardening possible through a combination of a cold cross-linking hardener and a hot cross-linking hardener. In this context, “cold cross-linking” means that the hardener only begins to cross-link at a particular temperature, which may be relatively low, but which in any case is lower than is the case with the hot cross-linking hardener. The cold cross-linking hardener may begin to cross-link for example from 0° C., in particular between approximately 0° C. and approximately 100° C. The “hot cross-linking” hardener begins to cross-link at higher temperatures, in particular at 130° C. or higher. Below these higher temperatures, no cross-linking occurs through the hot cross-linking hardener. By using substances which are free from phenol and formaldehyde and by using hardeners which do not split off any formaldehyde during the cross-linking reaction, the filter material according to the invention does not release phenol or formaldehyde into the environment at any point.

The impregnation advantageously consists of an epoxy resin comprising two or more epoxy groups from the group comprising bisphenols A and F and/or the glycidyl ethers of these bisphenols and the aliphatic epoxy resins comprising two or more epoxy groups. The epoxy resin is soluble in low alcohols and ketones, for example methanol, ethanol, isopropanol and acetone in any desired ratios. At least two different types of hardener are added to the epoxy resin.

The first type of hardener is a cold cross-linking hardener. The amount added is substoichiometric based on the epoxy resin, preferably 30-80% of the stoichiometric ratio and particularly preferably 50% of the stoichiometric ratio. The amount of this hardener is preferably selected such that, after drying, the filter medium according to the invention is already hardened to such an extent that it has sufficient strength for further processing but is still flexible enough that during further processing it can, without breaking, be embossed, folded into a bellows or provided with corrugations which extend transversely to the material web.

The second type of hardener is a hot cross-linking hardener. The amount added is substoichiometric based on the epoxy resin, preferably 30-80% of the stoichiometric ratio and particularly preferably 50% of the stoichiometric ratio. This resin preferably reacts from 130° C., more preferably from 150° C., and is only effective if the bellows is already completely formed when it enters the hardening oven.

Preferred hardeners of the first type are aliphatic hardeners (for example polyamidoamines and polyamides), modified aliphatic hardeners, cycloaliphatic amine hardeners, aromatic amines, ketimines and acid anhydrides.

Preferred hardeners of the second type are nitrogen-containing hardeners, for example dicyandiamide, guanamines, guanidines, cyanamine, triazines, triazoles, cyanamides or imidazoles. Dicyandiamide and mixtures of dicyandiamide with accelerators such as imidazoles are particularly preferred.

The final hardening, which is achieved substantially through the second type of hardener, gives the filter medium the required strength and rigidity in wet and dry states and good resistance to aggressive influences. Examples of aggressive influences which act on filter materials are hot engine oil at approximately 150° C. or hot fuel at approximately 80° C. Additives in these liquids further increase the aggressiveness thereof. When comparing a filter material according to the invention with a comparison material which is identical except that it is impregnated with phenolic resin, it has surprisingly been found that the filter material according to the invention is considerably more resistant to hot engine oil, hot air, AdBlue, fuels such as diesel and biodiesel and other liquid and gaseous substances to be filtered than the filter material impregnated with phenolic resin. All other physical and filtration-related values are comparable in the two materials (see Table 1).

The porous planar formation of the filter material according to the invention can, for example, be produced by the wet-laying method, the air-laying method, the melt-blown method or the spun-bonding method. In addition, it can consist of an open-pore foam.

The wet-laying method is understood to mean the conventional method for producing paper, in which a suspension of short cut fibres is produced using water and this suspension, which may additionally contain the conventional auxiliary agents for paper production, is spread out on a wire and drained. The porous planar formation thus formed is subsequently dried and rolled up.

In the air-laying method, the short cut fibres are swirled in an air stream and also laid on a wire. The porous planar formation is then compacted by means of needling, water-jet needling, heat application, etc. and rolled up.

In the spun-bonding method, a thermoplastic polymer is partially melted in an extruder and pressed through a spinning nozzle. After exiting the nozzle, the continuous fibres formed in the capillaries of the spinning nozzle are stretched, swirled in a delivery duct and laid in a web-like manner on a wire. The mat is then compacted using an embossing calendar with application of pressure and temperature.

In the melt-blown method, a thermoplastic polymer is partially melted in an extruder and pressed through a spinning nozzle. After exiting the nozzle, the continuous fibres formed in the capillaries of the spinning nozzle are stretched using hot air and laid in a web-like manner on a wire.

Polymers for the melt-blown and spun-bonding methods are preferably polyolefins, polyester, polyamides, polyphenylene sulphide, polycarbonate or copolymers or mixtures thereof.

Suitable fibres for the wet-laying and air-laying processes are, for example, cellulose, regenerated cellulose, polyester fibres, polyolefin fibres, polyamide fibres, multi-component fibres, glass fibres or carbon fibres.

Depending on the application, the filter materials according to the invention typically have a grammage according to DIN EN ISO 536 of 10-400 g/m², an air permeability according to DIN EN ISO 9237 of 2-10000 1/m²s and a thickness according to DIN ES ISO 534 of 0.1-5.0 mm.

The filter material according to the invention can be single or multi-layer, at least one layer being treated using the epoxy resin impregnation according to the invention.

AN established methods, for example dip impregnation, one or two-sided roller application or spray application, can be used as impregnation methods.

### Example 1

Paper having a grammage of 100 g/m² and an air permeability of 860 1/m²s was produced on an inclined wire paper machine, impregnated on the laboratory padder and dried in the circulating-air drying oven for 15 min at 80° C. The impregnation was carried out using a mixture of:

10 g epoxy resin araldite GY 250 produced by Huntsman
2 g hardener 1 SIQ amine 2030 produced by S.I.Q.
2 g hardener 2 dicyandiamide produced by Alzchem
0.5 g accelerator 2-methylimidazole produced by BASF
100 g methanol

The impregnating agent content was 19% by weight based on the mass per unit area of the impregnated medium. The bursting strength, air permeability, mass per unit area, bending strength lengthways when wet, bending strength lengthways when dry, back drying behaviour, resistance to hot oil, post-scaling behaviour and phenol and formaldehyde emission of this medium were then measured. The results are shown in Table 1.

### Comparison Example

Paper from Example 1 was impregnated with a standard phenolic resin of the following composition under the same conditions as in Example 1:

10 g phenolic resin 3195 produced by Dynea
100 g methanol

The impregnating agent content was 19% by weight based on the mass per unit area of the impregnated medium. The bursting strength, air permeability, mass per unit area, bending strength lengthways when wet, bending strength lengthways when dry, back drying behaviour, resistance to hot oil, post-scaling behaviour and phenol and formaldehyde emission of this medium were then measured. The results are shown in Table 1.

Air permeability according to DIN EN ISO 9237
Bursting strength according to Mullen according to DIN EN ISO 2758
Mass per unit area according to DIN EN ISO 536
Bursting strength when dry and wet according to Schlenker according to DIN 53864

### Resistance to Hot Oil

To determine the resistance to hot engine oil, the filter material is hardened in the circulating-air oven for 10 minutes at 165° C. The hardened, planar filter material is then stored for 3 weeks at 150° C. in Shell Helix Ultra 5W30 engine oil and then conditioned for a further 24 hours in the standard operating environment according to DEN EN ISO 20187. The bursting strength according to DIN EN ISO 2758 of the aged filter material is then determined and compared with the bursting strength of the non-aged filter material.

### Post-Scaling Behaviour

The sample to be tested is stored in the circulating-air oven for 24 hours at 160° C. After conditioning according to DIN EN ISO 20187, the bursting strength according to DIN EN ISO 2758 is determined.

### Back Drying Behaviour

First the air permeability according to DIN EN ISO 9237 of the sample which has been conditioned in accordance with DIN EN ISO 20187 is determined. The sample is then placed in distilled water for 10 minutes and subsequently quenched for 5 seconds between two blotting boards. The air permeability according to DIN EN ISO 9237 is then measured once again, the sample remaining in the switched-on apparatus until the original air permeability value is reached again. During this time, the differential pressure is maintained at 200 Pa. The air permeability value is read off immediately after the sample has been placed in the apparatus and every 30 seconds thereafter.

Determination of the formaldehyde content: Approximately 0.3 g of the material to be tested is placed in an oven. The emissions in distilled water are recorded using a gas sampler after 4 min at 180° C. The formaldehyde is then analysed colorimetrically. The reaction of the formaldehyde with 4-amino-3-hydrazino-5-mercapto-1,2,4-triazole is used for this purpose (VDI 3862 sheet 4).

Determination of the phenol content: Approximately 0.3 g of the material to be tested is placed in an oven. The emissions in diluted sodium hydroxide solution are recorded using a gas sampler after 4 min at 180° C. The phenol is then analysed colorimetrically. The reaction of the phenol with p-nitroaniline is used for this purpose (VDI 3485).

TABLE 1

| | Example 1 | Comparison |
|---|---|---|
| Test characteristic | (invention) | example |
| mass per unit area [g/m²] | 123 | 123 |
| air permeability [1/m²s] | 880 | 880 |
| bursting strength [kPa] | 391 | 321 |
| bending strength lengthways | 6.8 [cNcm²] | 9.3 [cNcm²] |
| when wet | | |
| bending strength lengthways | 55 [cNcm²] | 51 [cNcm²] |
| when dry | | |
| back drying behaviour | 2 minutes | 5 minutes |
| post-scaling behaviour | 462 kPa | 180 kPa |
| resistance to hot oil | 233 [kPa] | 188 [kPa] |
| phenol emission 4 min | below the detection | 0.2.89 [g/kg paper] |
| 180° C. | limit | |
| formaldehyde emission 4 min | below the detection | 0.646 [g/kg paper] |
| 180° C. | limit | |

The results show clearly that the filter material according to the invention (Example 1) is considerably superior to the filter material impregnated with phenolic resin (comparison example) used to date. Only the bending strength lengthways when wet is somewhat lower in the case of the filter material according to the invention, but this value is still within the usual range for these filter materials.

1. Single or multi-layer filter material in which at least one layer consisting of cellulose, glass fibres, synthetic fibres or a mixture thereof is impregnated with a binder which consists of an epoxy resin and a hardening agent, characterised in that the hardening agent comprises a first hardener cross-linking at a lower temperature and a second hardener cross-linking at a higher temperature, in such a way that the epoxy resin can be hardened stepwise as a function of temperature.

2. Filter material according to claim 1, characterised in that the first hardener is a hardener which begins to cross-link from a temperature of 0° C.

3. Filter material according to claim 1, characterised in that the second hardener is a hardener which begins to cross-link from a temperature of 130° C.

4. Filter material according to claim 1, characterised in that the first hardener is present in the binder at 30-80% of the stoichiometric ratio based on the epoxy resin.

5. Filter material according to claim 1, characterised in that the second hardener is present in the binder at 30-80% of the stoichiometric ratio based on the epoxy resin.

6. Filter material according to claim 1, characterised in that the first hardener is a hardener originating from the group comprising the aliphatic and/or cycloaliphatic amine hardeners.

7. Filter material according to claim 6, characterised in that the first hardener is a polyamidoamine.

8. Filter material according to claim 1, characterised in that the second hardener is a nitrogen-containing hardener.

9. Filter material according to claim 8, characterised in that the second hardener is a dicyandiamide, guanamine or imidazole.

10. Filter material according to claim 8, characterised in that the second hardener contains an accelerator.

11. Filter element produced from a single or multi-layer filter material according to claim 1.

12. Filter element according to claim 11, characterised in that the filter element is pleated.

13. Filter element according to claim 11, characterised in that the filter material is grooved in the longitudinal direction.

14. Filter element according to claim 11, characterised in that the filter material is embossed.

15. Filter element according to claim 11, characterised in that the filter material is corrugated in the transverse direction.

16. Method for producing a single or multi-layer filter material, the method comprising the following steps:
a) producing a binder which can be hardened stepwise as a function of temperature and consists of epoxy resin and a hardening agent which comprises a first hardener cross-linking from a lower temperature and a second hardener cross-linking from a higher temperature,
b) impregnating at least one layer of the filter material, which consists of cellulose, glass fibres, synthetic fibres or a mixture thereof, with the binder which can be hardened stepwise,
c) pre-hardening the filter material by exposing the filter material to a temperature which corresponds at least to the lower temperature but is below the higher temperature.
d) shaping the layer,
e) hardening the filter material by exposing the filter material to a temperature which is equal to or higher than the higher temperature.

17. Method according to claim 16, characterised in that the step of pre hardening the filter material is carried out at a temperature between 0° C. and 120° C., while the hardening step is carried out at temperatures from 130° C.
